(19) United States
(12) Patent Application Publication
(10) Pub. No.: US 2008/0063063 A1
(43) Pub. Date: Mar. 13, 2008

(54) ELECTRONIC DEVICE AND METHOD FOR BLOCK-BASED IMAGE PROCESSING

(75) Inventors: Robert Hugo GELDERBLOM, Eindhoven (NL); Lambertus Antonius VAN EGGELEN, Eindhoven (NL); Marco Klaas BOSMA, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,537

(22) PCT Filed: Jun. 20, 2005
(86) PCT No.: PCT/IB05/52020

§ 371 Date: Dec. 13, 2006

(30) Foreign Application Priority Data
Jun. 24, 2004 (EP) 04102930.7

(51) Int. Cl. H04N 11/02; H04N 1/41

(52) U.S. Cl. 375/240.16; 358/426.01

(57) ABSTRACT

The electronic device comprises electronic circuitry which functionally comprises a boundary detector, an analyzer and an includer. The boundary detector is operative to determine a boundary (47) between a relevant area (45) and an irrelevant area (43) of an image (41). The analyzer is operative to analyze blocks (55) of pixels intersected by the boundary (47). The includer is operative to include blocks (55) of pixels intersected by the boundary (47) in the relevant area (45) in dependence upon the analysis. The invention further relates to a method of determining a relevant area of an image for block-based image processing. The method comprises the steps of determining a boundary between a relevant and an irrelevant area of an image, analyzing blocks of pixels intersected by the boundary and including blocks of pixels intersected by the boundary in the relevant area in dependence upon the analysis. The invention also relates to control software for making a programmable device operative to perform the method of the invention and to electronic circuitry for use in the device of the invention.

The invention relates to an electronic device which is capable of determining a relevant area of an image for block-based image processing.

The invention also relates to electronic circuitry for use in such a device.

The invention further relates to a method of determining a relevant area of an image for block-based image processing.

The invention also relates to control software for making a programmable device operative to perform such a method.

An example of such a device and method is known from internationally published patent application WO 03/071805. This document describes distinguishing a relevant area (e.g. content) and an irrelevant area (e.g. black borders in a 16:9 video segment distributed in 4:3 format) in an image. In order to efficiently compress black borders, the boundaries between the black borders and the content are aligned to block boundaries (e.g. of 8×8 blocks of pixels) by blackening partially filled blocks. This method has the drawback that removed lines of content can sometimes be very noticeable and irritating to viewers.

It is a first object of the invention to provide an electronic device of the type described in the opening paragraph, which reduces the perceptibility of image processing of images comprising a relevant and an irrelevant area.

It is a second object of the invention to provide a method of the type described in the opening paragraph, which reduces the perceptibility of image processing of images comprising a relevant and an irrelevant area.

According to the invention, the first object is realized in that the electronic device comprises electronic circuitry, the electronic circuitry functionally comprising a boundary detector for determining a boundary between a relevant and an irrelevant area of an image, an analyzer for analyzing blocks of pixels intersected by the boundary, and an includer for including blocks of pixels intersected by the boundary in the relevant area in dependence upon the analysis. The electronic device may determine the relevant area of the image, for example, in order to compress a single image (e.g. using JPEG), to compress a plurality of (moving) images (e.g. using MPEG-2 video compression), or to increase the field/frame rate of a plurality of images (e.g. using Philips Digital Natural Motion technology). In some devices, an image processor is referred to as video processor, depending on the main function of the device. Movies or television programs that have been converted from one aspect ratio to another, e.g. from 16:9 to 4:3, often show black bars around the picture (either top and bottom, or left and right). When the field/frame rate is increased (e.g. using Philips Digital Natural Motion technology in 100 Hz televisions), incorrect motion vectors may cause black artefacts in the picture. However, removing lines of content as described in WO 03/071805 can sometimes be even more noticeable than the artefacts. The inventors have recognized that removing lines of content is mostly noticeable when the edges of the relevant area contain vital information, such as subtitles or logos. By analyzing the edges of the relevant area, an independent decision to process the edge can be made for each image. The electronic device may be, for example, a PC, a television, a set-top box, a video recorder, a video player, or another type of CE device.

In an embodiment of the electronic device of the invention, the analyzer is operative to determine a similarity between first pixels on one side of the boundary and second pixels on another side of the boundary, the first and second pixels being located near the boundary, and the includer is operative to include blocks of pixels intersected by the boundary in the relevant area if the determined similarity exceeds a similarity threshold. Although it may be possible to detect vital information in other ways, such as determining for how many pixels in the blocks of pixels intersected by the boundary the luminance exceeds a certain threshold, in order to detect subtitles, this embodiment has proved most effective in experiments. The luminance of a first pixel is preferably compared with the luminance of a second pixel. The first and second pixels are preferably adjacent pixels.

The similarity threshold may be determined in dependence upon a quality of the blocks intersected by the boundary. The quality of the blocks intersected by the boundary may be, for example, a noise level measured for the entire image or an estimated chance of artefacts in the blocks intersected by the boundary. If there is a great chance of artefacts, it is advantageous to increase the similarity threshold, making it less likely that low-quality blocks intersected by the boundary are included in the relevant area. For the same purpose, other parameters used in the method or the device of the invention may also be (dynamically) determined in dependence upon a quality of the boundary-intersected blocks.

The boundary detector may be operative to determine a plurality of likely boundaries between a relevant and an irrelevant area of an image. The analyzer may be operative to determine a similarity between first pixels on one side of a likely boundary and second pixels on another side of the likely boundary for each likely boundary, the first and second pixels being located near the likely boundary. The analyzer may further be operative to determine a final boundary based on the similarities determined for each likely boundary. The includer may be operative to include blocks of pixels intersected by the final boundary in the relevant area if the determined similarity of the final boundary exceeds a similarity threshold. Removing lines of non-vital information pixels is often least noticeable when the boundary used by the includer is a boundary between the two most different lines of pixels near a black border. The likely boundaries are preferably adjacent boundaries (e.g. the first and second pixels are separated by the first likely boundary, the second and third pixels are separated by the second likely boundary, etc.).

The electronic circuitry may further comprise an image processor operative to assign a default value to the blocks of pixels intersected by the boundary if said blocks of pixels are not included in the relevant area. Many image-processing algorithms (e.g. MPEG-2 video compression) automatically process black areas more efficiently and/or more accurately. Blackening the blocks of pixels intersected by the boundary can ensure that subsequent image-processing steps automatically process the image more efficiently and/or more accurately.

The boundary detector may be operative to determine a boundary by analyzing lines of pixels starting from an edge of the image and locating a first line of pixels, at least one pixel of which has a value that is part of a certain set of values. If a pixel has a luminance value above a certain level (e.g. a value between 28 and 256), this pixel is most likely not part of the black border. The boundary is preferably selected in such a way that it separates the first and the previous line of pixels.

The electronic circuitry may comprises an image processor operative to process image data from a relevant area previously determined for at least one previous image of a video sequence which comprises said image if the previously determined relevant area is not smaller than said relevant area by more than a pre-determined amount, and the image processor processes image data from said relevant area otherwise. To avoid frequent changes in the area that is actually being processed (frequent changes can also become noticeable), a previously determined relevant area (not image data, but coordinates or block numbers, for example) may be used instead of the currently determined relevant area, unless the currently determined relevant area is larger than the previously determined relevant area by more than a pre-defined amount (e.g. 2 blocks in height or width), in which case the image data in the relevant area is likely to be vital information, like a subtitle.

The image processor may be operative to process image data from an area previously used in processing a preceding image of the video sequence if relevant areas similar to said relevant area have recently been determined relatively rarely for previous images in the video sequence. Thus, the currently determined relevant area may also be used if the same relevant area has recently been determined relatively often. If this is not the case, the area previously used in processing a preceding image is used in order to avoid frequent changes in the area that is actually being processed.

The analyzer may be operative to determine the similarity between the first and second pixels in dependence upon a determined number of segments of first pixels, in which each pixel value is different than a corresponding pixel value of opposite segments of second pixels by at least a certain amount. This type of segmenting has experimentally proved to provide an accurate measure of similarity.

According to the invention, the second object is realized in that the method comprises the steps of determining a boundary between a relevant and an irrelevant area of an image, analyzing blocks of pixels intersected by the boundary, and including blocks of pixels intersected by the boundary in the relevant area in dependence upon the analysis. The method is performed, for example, by a dedicated image processor in a consumer electronic device or by a general-purpose processor in a general-purpose computer.

In an embodiment of the method of the invention, the step of analyzing blocks of pixels intersected by the boundary comprises determining a similarity between first pixels on one side of the boundary and second pixels on another side of the boundary, the first and second pixels being located near the boundary, and the step of including blocks of pixels intersected by the boundary in the relevant area in dependence upon the analysis comprises including blocks of pixels intersected by the boundary in the relevant area if the similarity determined for the boundary exceeds a similarity threshold.

The similarity threshold may be determined in dependence upon a quality of the blocks intersected by the boundary.

The step of determining a boundary between a relevant and an irrelevant area of an image may comprise determining a plurality of likely boundaries between a relevant and an irrelevant area of an image. Determining a similarity between first pixels on one side of the boundary and second pixels on another side of the boundary may comprise determining a similarity between first pixels on one side of a likely boundary and second pixels on another side of the likely boundary for each likely boundary. The method may further comprise the step of determining a final boundary based on the similarities determined for each likely boundary. Including blocks of pixels intersected by the boundary in the relevant area if the determined similarity exceeds a similarity threshold may comprise including blocks of pixels intersected by the final boundary in the relevant area if the determined similarity of the final boundary exceeds a similarity threshold.

The method may further comprise the step of assigning a default value to the blocks of pixels intersected by the boundary if said blocks of pixels are not included in the relevant area.

The step of determining a boundary may comprise analyzing lines of pixels starting from an edge of the image and locating a first line of pixels, at least one pixel of which has a value that is part of a certain set of values.

The method may further comprise the step of processing image data from a relevant area previously determined for at least one previous image of a video sequence which comprises said image if the previously determined relevant area is not smaller than said relevant area by more than a pre-determined amount, and processing image data from said relevant area otherwise.

The previously determined relevant area may be an area previously used in processing a preceding image of the video sequence if relevant areas similar to said relevant area have recently been determined relatively rarely for previous images in the video sequence.

The similarity between the first and second pixels may depend on a determined number of segments of first pixels, in which each pixel value is different than a corresponding pixel value of opposite segments of second pixels by at least a certain amount.

These and other aspects of the electronic device and method of the invention will be further elucidated and described with reference to the drawings, in which:

FIG. 1 is a flow chart of the method of the invention;

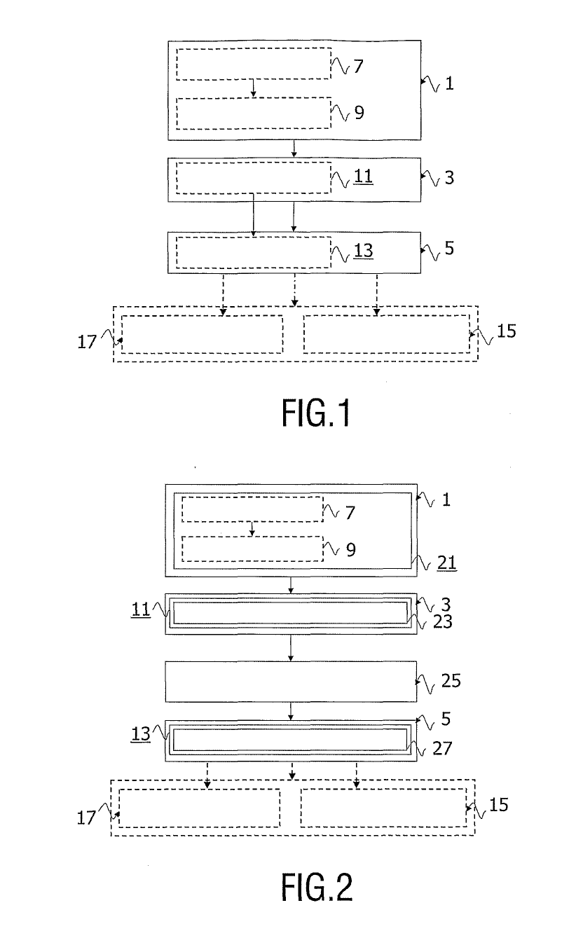

FIG. 2 is a flow chart of an embodiment of the method of the invention;

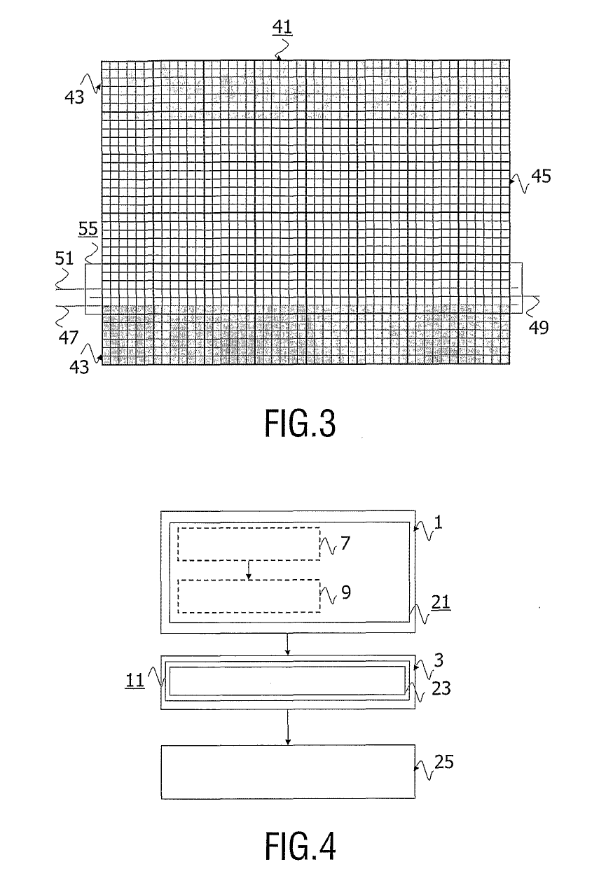

FIG. 3 is an example of an image which can be processed with the method or the electronic device of the invention;

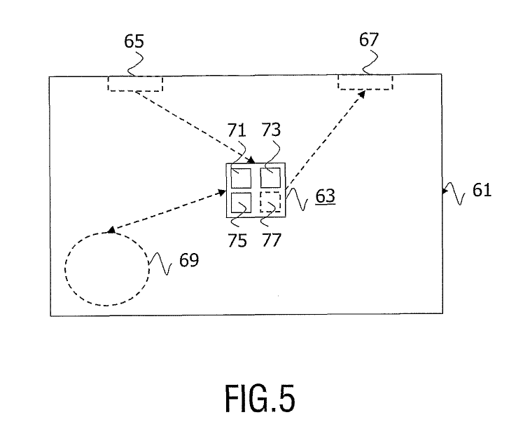

FIG. 4 is a flow chart of an improved method of detecting a boundary between a relevant and an irrelevant area in an image; and

FIG. 5 is a block diagram of the electronic device of the invention.

Corresponding elements in the drawings are identified by the same reference numerals.

The method of the invention, see FIGS. 1 and 3, comprises a step 1 of determining a boundary 47 between a relevant area 45 and an irrelevant area 43 of an image 41, a step 3 of analyzing blocks 55 of pixels intersected by the boundary 47, and a step 5 of including blocks 55 of pixels intersected by the boundary 47 in the relevant area 45 in dependence upon the analysis. Step 1 of determining a boundary 47 may comprise a step 7 of analyzing lines of pixels starting from an edge of the image 41 and a step 9 of locating a first line of pixels, at least one pixel of which has a value that is part of a certain set of values. This may entail, for example, looking for a first line that has a pixel value above a certain level (e.g. above the black level of 28 in case 256 luminance values are used).

Step 3 of analyzing blocks 55 of pixels intersected by the boundary 47 may comprise a step 11 of determining a similarity between first pixels on one side of the boundary 47 and second pixels on another side of the boundary 47, the first and second pixels being located near the boundary 47. If step 3 comprises step 11, step 5 of including blocks 55 of pixels intersected by the boundary 47 in the relevant area 45 in dependence upon the analysis comprises step 13 of including blocks 55 of pixels intersected by the boundary 47 in the relevant area 45 if the similarity determined for the boundary 47 exceeds a similarity threshold. The similarity between the first and second pixels may depend on a determined number of segments (e.g. of 8 pixels) of first pixels, in which each pixel value is different than a corresponding pixel value of opposite segments of second pixels by at least a certain amount. This may entail, for example, counting the number of segments, where each pixel in the first non-black line is brighter than the neighboring pixel in the last black line by at least a certain amount (e.g. 4). If the percentage of counted segments with respect to the total amount of segments exceeds the similarity threshold (e.g. 50%), the boundary 47 may be considered a ‘sharp edge’. If a ‘sharp edge’ was found (the similarity was not sufficiently high), the blocks 55 of pixels intersected by the boundary 47 should not be included in the relevant area 45. The similarity threshold and/or the certain amount by which each pixel value should at least be different than a corresponding pixel may be determined in dependence upon a quality of the blocks intersected by the boundary. The quality of the boundary-intersected blocks may be, for example, a noise level measured for the entire image or an estimated chance of artefacts in these blocks. The chance of artefacts may be estimated, for example, by comparing motion vectors of different blocks intersected by the boundary. There is a great chance of artefacts if the motion vectors are inconsistent, especially when fast movements occur in the video sequence. If there is a great chance of artefacts, it is advantageous to increase the similarity threshold and/or decrease the certain amount by which each pixel value should at least be different than a corresponding pixel, thereby making it less likely that low-quality blocks intersected by the boundary will be included in the relevant area.

The method of the invention may further comprise a step 17 of processing image data from a relevant area previously determined for at least one previous image of a video sequence which comprises said image 41 if the previously determined relevant area is not smaller than said relevant area 45 by more than a predetermined amount, and processing image data from said relevant area 45 otherwise. The previously determined relevant area may be an area previously used in processing a preceding image of the video sequence if relevant areas similar to said relevant area 45 have recently been determined relatively rarely for previous images in the video sequence. This may entail, for example, making a histogram of the relevant areas corresponding to ‘sharp edges’ that were found in the last few seconds (e.g. for the last 120 frames) and inserting the previously used relevant area a couple of times (e.g. 80 times) if the previously used relevant area corresponds to a ‘sharp edge’. If no relevant area corresponding to a ‘sharp edge’ is present in the histogram, image data from the currently determined relevant area should be processed. If a relevant area corresponding to a ‘sharp edge’ is present in the histogram, image data from the previously determined relevant area corresponding to the sharp edge that has the highest value in the histogram (i.e. a relevant area that has previously been determined relatively often) should be processed, unless the currently determined relevant area 45 is larger than this previously determined relevant area by a pre-determined amount (e.g. 2 blocks in width or height). In the latter case, image data from the currently determined relevant area 45 should be processed. The pre-determined amount may be lowered when at least a certain number of white pixels are detected in the blocks of pixels intersected by the boundary 47. The algorithm for selecting a relevant area to be used in processing the current image may take a quality of the boundary-intersected blocks into account in order to decrease the number of frames in which the relevant area includes low-quality boundary-intersected blocks.

To make the actually used relevant area more stable with respect to time, a hold time can be implemented: after a decrease in the actually used relevant area, the actually used relevant area will not be increased for a certain period of time. The hold time may be (dynamically) determined in dependence upon a quality of the blocks intersected by the boundary. If the boundary-intersected blocks have a low quality, it is advantageous to decrease the hold time, thereby decreasing the number of frames in which the relevant area includes low-quality boundary-intersected blocks. Of course, changes in the relevant area are consequently likely to occur more frequently.

The method of the invention may further comprise a step 15 of assigning a default value to the blocks 55 of pixels intersected by the boundary 47 if said blocks 55 of pixels are not included in the relevant area 45. This may entail, for example, blackening pixels that were determined to be irrelevant in order to make subsequent image processing steps more efficient and/or accurate. Steps 15 and 17 could be combined in a single step.

An embodiment of the method is shown in FIG. 2 (see also FIG. 3). In this embodiment, step 1 of determining a boundary between a relevant area 45 and an irrelevant area 43 of an image 41 comprises a step 21 of determining a plurality of likely boundaries 47, 49 and 51 (e.g. 3 boundaries between 4 consecutive lines of pixels) between a relevant area 45 and an irrelevant area 43 of an image 41. Furthermore, step 11 of determining a similarity between first pixels on one side of the boundary and second pixels on another side of the boundary comprises a step 23 of determining a similarity between first pixels on one side of a likely boundary and second pixels on another side of the likely boundary for each likely boundary 47, 49 and 51. This embodiment further comprises a step 25 of determining a final boundary based on the similarities determined for each likely boundary 47, 49 and 51 (e.g. selecting the boundary with the highest percentage of brighter segments). Also, step 13 of including blocks 55 of pixels intersected by the boundary in the relevant area 45 if the determined similarity exceeds a similarity threshold comprises a step 27 of including blocks 55 of pixels intersected by the final boundary in the relevant area 45 if the determined similarity of the final boundary exceeds a similarity threshold (e.g. higher than 50%).

A method similar to this embodiment of the method of the invention is shown in FIG. 4. This similar method does not include step 5 of including blocks of pixels intersected by the boundary in the relevant area in dependence upon the analysis and therefore does not include steps 13 or 27 either. This method can be used, for example, in situations in which it is not necessary to align the boundary between a relevant and an irrelevant area with block boundaries, e.g. in image-processing algorithms that are not block-based.

The electronic device 61 of the invention, see FIG. 5, comprises electronic circuitry 63. The electronic circuitry 63 functionally comprises a boundary detector 71, an analyzer 73, and an includer 75. The boundary detector 71 is operative to determine a boundary between a relevant and an irrelevant area of an image. The analyzer 73 is operative to analyze blocks of pixels intersected by the boundary. The includer 75 is operative to include blocks of pixels intersected by the boundary in the relevant area in dependence upon the analysis. The electronic device 61 may be, for example, a PC, a television, a set-top box, a video recorder, a video player, or another type of CE device. The logic circuitry may be, for example, a Philips Trimedia media processor or a Philips Nexperia audio video input processor. The electronic device 61 may further comprise an input 65, e.g. a SCART, composite, SVHS or component socket or a TV tuner. The electronic device 61 may further comprise an output 67, e.g. a SCART, composite, SVHS or component socket or a wireless transmitter. Alternatively, the electronic device 61 may comprise a display with which the electronic circuitry 63 is coupled (not shown). The electronic device 61 may also comprise storage means 69. Storage means 69 may be used, for example, for storing unprocessed and processed image data and/or for storing information with regard to previously determined relevant areas. The image may be a photograph or, for example, a video frame.

The electronic circuitry 63 may further comprise an image processor 77 operative to assign a default value to the blocks of pixels intersected by the boundary if said blocks of pixels are not included in the relevant area. Alternatively or additionally, the image processor 77 may be operative to process image data from a relevant area previously determined for at least one previous image of a video sequence which comprises said image if the previously determined relevant area is not smaller than said relevant area by more than a pre-determined amount, and the image processor processes image data from said relevant area otherwise. The boundary detector 71, the analyzer 73, the includer 75, and the image processor 77 may be, for example, software executable by the electronic circuitry 63. The electronic circuitry 63 may comprise one or more integrated circuits.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements or steps other than those stated in the claims. Use of the article “a” or “an” preceding an element does not exclude the presence of a plurality of such elements or steps.

As will be apparent to a person skilled in the art, ‘means’ are understood to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. ‘Control software’ is to be understood to mean any software product stored on a computer-readable medium, such as a floppy disk, downloadable via a network, such as the Internet, or marketable in any other manner.

1. An electronic device (61), comprising electronic circuitry (63), the electronic circuitry (63) functionally comprising:
a boundary detector (71) for determining a boundary (47) between a relevant area (45) and an irrelevant area (43) of an image (41);
an analyzer (73) for analyzing blocks (55) of pixels intersected by the boundary (47); and
an includer (75) for including blocks (55) of pixels intersected by the boundary (47) in the relevant area (45) in dependence upon the analysis.

2. An electronic device (61) as claimed in claim 1, wherein:
the analyzer (73) is operative to determine a similarity between first pixels on one side of the boundary (47) and second pixels on another side of the boundary (47), the first and second pixels being located near the boundary (47); and
the includer (75) is operative to include blocks (55) of pixels intersected by the boundary (47) in the relevant area (45) if the determined similarity exceeds a similarity threshold.

3. An electronic device (61) as claimed in claim 2, wherein the similarity threshold is determined in dependence upon a quality of the blocks intersected by the boundary.

4. An electronic device (61) as claimed in claim 2, wherein:
the boundary detector (71) is operative to determine a plurality of likely boundaries (47, 49, 51) between a relevant area (45) and an irrelevant area (43) of an image (41);
the analyzer (73) is operative to determine a similarity between first pixels on one side of a likely boundary (47, 49, 51) and second pixels on another side of the likely boundary (47, 49, 51) for each likely boundary (47, 49, 51), the first and second pixels being located near the likely boundary (47, 49, 51);
the analyzer (73) is further operative to determine a final boundary based on the similarities determined for each likely boundary (47, 49, 51); and
the includer (75) is operative to include blocks (55) of pixels intersected by the final boundary in the relevant area (45) if the determined similarity of the final boundary exceeds a similarity threshold.

5. An electronic device (61) as claimed in claim 1, wherein the electronic circuitry (63) further comprises an image processor (77) operative to assign a default value to the blocks (55) of pixels intersected by the boundary if said blocks (55) of pixels are not included in the relevant area (45).

6. An electronic device (61) as claimed in claim 1, wherein the boundary detector (71) is operative to determine a boundary (47) by analyzing lines of pixels starting from an edge of the image (45) and locating a first line of pixels, at least one pixel of which has a value that is part of a certain set of values.

7. An electronic device (61) as claimed in claim 1, wherein the electronic circuitry (63) further comprises an image processor (77) operative to process image data from a relevant area previously determined for at least one previous image of a video sequence which comprises said image (41) if the previously determined relevant area is not smaller than said relevant area (45) by more than a pre-determined amount, and the image processor (63) processes image data from said relevant area (45) otherwise.

8. An electronic device (61) as claimed in claim 7, wherein the image processor (77) is operative to process image data from an area previously used in processing a preceding image of the video sequence if relevant areas similar to said relevant area (45) have recently been determined relatively rarely for previous images in the video sequence.

9. An electronic device (61) as claimed in claim 1, wherein the analyzer (73) is operative to determine the similarity between the first and second pixels in dependence upon a determined number of segments of first pixels, in which each pixel value is different than a corresponding pixel value of opposite segments of second pixels by at least a certain amount.

10. Electronic circuitry for use in the device of claim 1.

11. A method of determining a relevant area of an image for block-based image processing, the method comprising the steps of:
determining (1) a boundary between a relevant and an irrelevant area of an image;
analyzing (3) blocks of pixels intersected by the boundary; and
including (5) blocks of pixels intersected by the boundary in the relevant area in dependence upon the analysis.

12. A method as claimed in claim 11, wherein:
the step of analyzing (3) blocks of pixels intersected by the boundary comprises determining (11) a similarity between first pixels on one side of the boundary and second pixels on another side of the boundary, the first and second pixels being located near the boundary; and
the step of including (5) blocks of pixels intersected by the boundary in the relevant area in dependence upon the analysis comprises (13) including blocks of pixels intersected by the boundary in the relevant area if the similarity determined for the boundary exceeds a similarity threshold.

13. A method as claimed in claim 12, wherein the similarity threshold is determined in dependence upon a quality of the blocks intersected by the boundary.

14. A method as claimed in claim 12, wherein:
the step of determining (1) a boundary between a relevant and an irrelevant area of an image comprises determining (21) a plurality of likely boundaries between a relevant and an irrelevant area of an image;
the step of determining (11) a similarity between first pixels on one side of the boundary and second pixels on another side of the boundary comprises determining (23) a similarity between first pixels on one side of a likely boundary and second pixels on another side of the likely boundary for each likely boundary;
further comprised is the step of determining (25) a final boundary based on the similarities determined for each likely boundary; and
the step of including (13) blocks of pixels intersected by the boundary in the relevant area if the determined similarity exceeds a similarity threshold comprises including (27) blocks of pixels intersected by the final boundary in the relevant area if the determined similarity of the final boundary exceeds a similarity threshold.

15. Control software for making a programmable device operative to perform the method of claim 11.
